(19) United States
(12) Patent Application Publication
(10) Pub. No.: US 2013/0132665 A1
(43) Pub. Date: May 23, 2013

(54) HARDDISK DRIVE CONNECTOR HAVING INDICATION DEVICE FOR INDICATING DATA TRANSFER RATE AND COMPUTING DEVICE HAVING THE SAME

(71) Applicants: HONG FU JIN PRECISION INDUSTRY (ShenZhen, ShenZhen (CN); HON HAI PRECISION INDUSTRY CO., LTD., New Taipei (TW)

(72) Inventors: KANG WU, Shenzhen (CN); BO TIAN, Shenzhen (CN)

(73) Assignees: HON HAI PRECISION INDUSTRY CO., LTD., New Taipei (TW); HONG FU JIN PRECISION INDUSTRY (ShenZhen) CO., LTD, ShenZhen (CN)

(21) Appl. No.: 13/672,779

(22) Filed: Nov. 9, 2012

(30) Foreign Application Priority Data
Nov. 18, 2011 (CN) 201110367861.X

(51) Int. Cl. G06F 12/00

(52) U.S. Cl. 711/112; 711/E12.001

(57) ABSTRACT

A hard disk drive (HDD) connector includes a plurality of HDD interfaces being connected to a plurality of HDDs, and a data transfer rate (DTR) indication device for indicating a DTR of each of the HDDs connected to the HDD interfaces. The DTR indication device includes an indication unit, a setting unit, and a control unit. The indication unit defines a plurality of indication states, each of which indicates a type of DTR of the HDDs. The setting unit sets a control command that represents the DTR of the HDD connected to each of the HDD interfaces. The control unit receives the control command from the setting unit, and controls the indication unit to work at a corresponding indication state according to the control command, to indicate the DTR of each of the HDDs connected to the HDD interfaces.

### BACKGROUND

1. Technical Field

Embodiments of the present disclosure relate to hard disk drives, and particularly to a hard disk drive connector having an indication device for indicating data transfer rate.

2. Description of Related Art

Many computer systems use a plurality of hard disk drives (HDDs) to provide large storage capacity for users. For example, in a storage system, an HDD backpanel is installed to support multiple HDDs. Different HDDs may have different data transfer rates (DTR) that represent a speed at which data can be transmitted between devices. Each HDD may have at least one indicator such as an LED to indicate whether the HDD works normally. However, the indicator does not indicate the DTR of the HDD, which is very inconvenient when a user want to check the DTR of each HDD presented on the HDD backpanel. Therefore, there is room for improvement in the art.

### BRIEF DESCRIPTION OF THE DRAWINGS

FIG. 1 illustrates a schematic diagram of one embodiment of a computing device including a hard disk drive (HDD) connector.

FIG. 2 is a schematic block diagram of one embodiment of a data transfer rate (DTR) indication device of the HDD connector of FIG. 1.

FIG. 3 shows a chart of an example of a table that stores various DTR of different HDDs corresponding to different commands.

FIG. 4 is a schematic block diagram of another embodiment of the DTR indication device of the HDD connector of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one”.

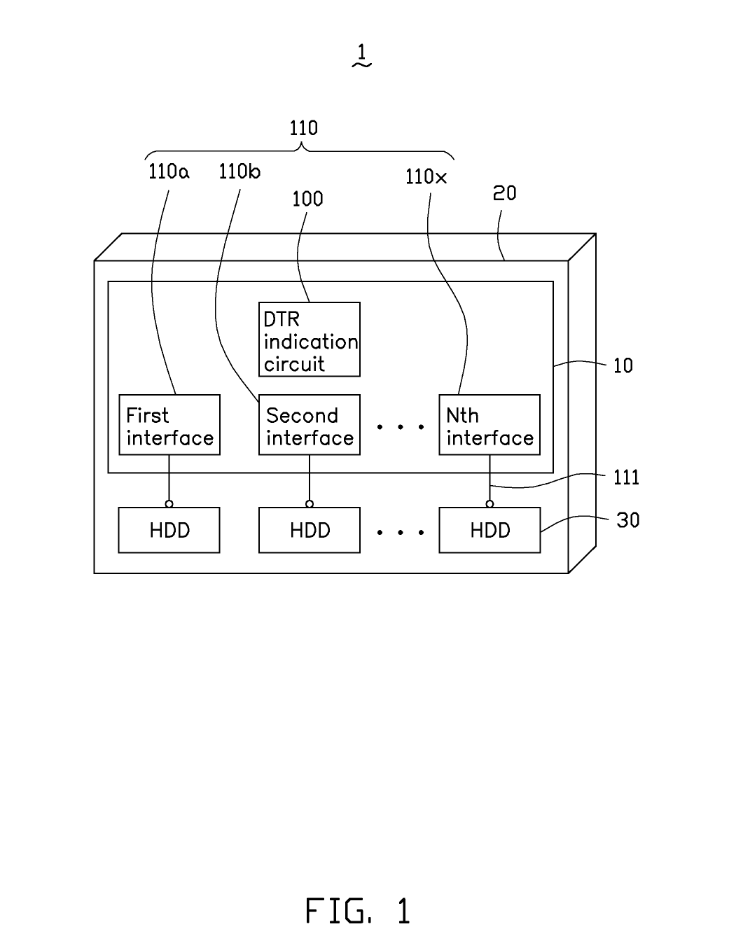

FIG. 1 illustrates a schematic diagram of one embodiment of a computing device 1. The computer device 1 includes a hard disk drive (HDD) connector 10. The computing device 1 may be, for example, a computer, a server, or other similar computing device. The HDD connector 10 may be an HDD backpanel installed on an HDD holding structure 20 of the computing device 1 to support multiple HDDs. The HDD connector 10 includes a plurality of HDD interfaces 110, such as a first interface 110a, a second interface 110b . . . an Nth interface 110x of FIG. 1. Each of the HDD interfaces is configured for connecting an HDD 30. The HDD interfaces may be, for example, SATA® 3.0 interfaces that support various HDDs having different data transfer rate (DTR) (e.g., 1.5 Gbps, 3.5 Gbps, and 6.0 Gbps). In the embodiment, each of the HDDs 30 connected to the HDD interfaces 110 may have a same DTR, so that avoiding data error during data transferring of the HDDs 30. FIG. 1 shows one example of the computing device 1, in other embodiments, the computing device 1 can include more or fewer components such as a motherboard to where the HDD connector 10 is connected, or have a different configuration of the components.

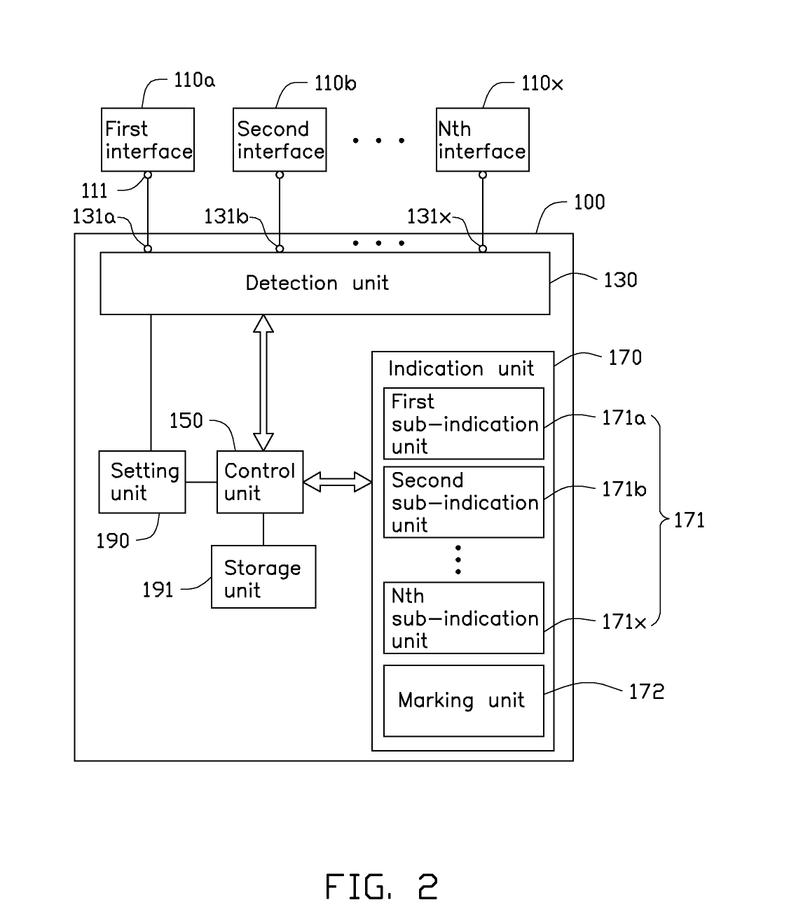

Each of the HDD interfaces 110 includes a plurality of connection ports (not shown) corresponding to connection pins (not shown) of the HDD 30. As shown in FIG. 2, the connection ports include at least a first detection port 111 that is used to detect whether the HDD 30 is connected to the HDD interface 110. In one example, when the HDD 30 is connected to the HDD interface 110, a low level voltage (e.g., 0V) is outputted through the first detection port 111. When the HDD 30 is disconnected from the HDD interface 110, a high level voltage (e.g., 5V or 3.3V) is outputted through the first detection port 111.

The HDD connector 10 further includes a DTR indication device 100 configured for indicating a DTR of each HDD 30 presented on the HDD connector 10. In one embodiment, as shown in FIG. 2, the DTR indication device 100 includes a detection unit 130, a control unit 150, an indication unit 170, a setting unit 190, and a storage unit 191. The control unit 150 is electrically connected to the detection unit 130, the indication unit 170, the setting unit 190, and the storage unit 191. The detection unit 130 includes a plurality of second detection ports 131 (e.g., 131a, 131b . . . 131x of FIG. 2) corresponding to the first detection port 111 of each of the HDD interfaces 110. Each of the second detection ports 131 is electrically connected to the first detection port 111 of each of the HDD interfaces 110. The detection unit 130 detects the HDD 30 connected to each of the HDD interfaces 110 by obtaining the voltage outputted from the first detection port 111 of each of the HDD interfaces 110.

The indication unit 170 includes a plurality of sub-indication units 171, such as a first sub-indication unit 171a, a second sub-indication unit 171b, . . . , an Nth sub-indication unit 171x of FIG. 2. The indication unit 170 defines a plurality of indication states, each of which indicates a type of DTR of the HDDs 30, such as 1.5 Gbps, 3.0 Gbps, or 6.0 Gbps, using each of the sub-indication units 171. In the embodiment, a number of the sub-indication units 171 is equal to a number of the HDD interfaces 110. Each of the sub-indication units 171 corresponds to one of the HDD interfaces 110, to indicate the DTR of the HDD 30 connected to each of the HDD interfaces 110. Each of the sub-indication units 171 may be a light indicator, such as a double-color light emitting diode (LED) or a multi-color LED. The plurality of indication states are defined using the sub-indication unit 170 to emit different colored light and/or flash with different colored light. For example, a first indication state which indicates a DTR of 1.5 Gbps is defined when the sub-indication unit 170 emits blue light. A second indication state which indicates a DTR of 1.5 Gbps is defined when the sub-indication unit 170 emits red light. A third indication state which indicates a DTR of 6.0 Gbps is defined when the sub-indication unit 170 flashes with red light.

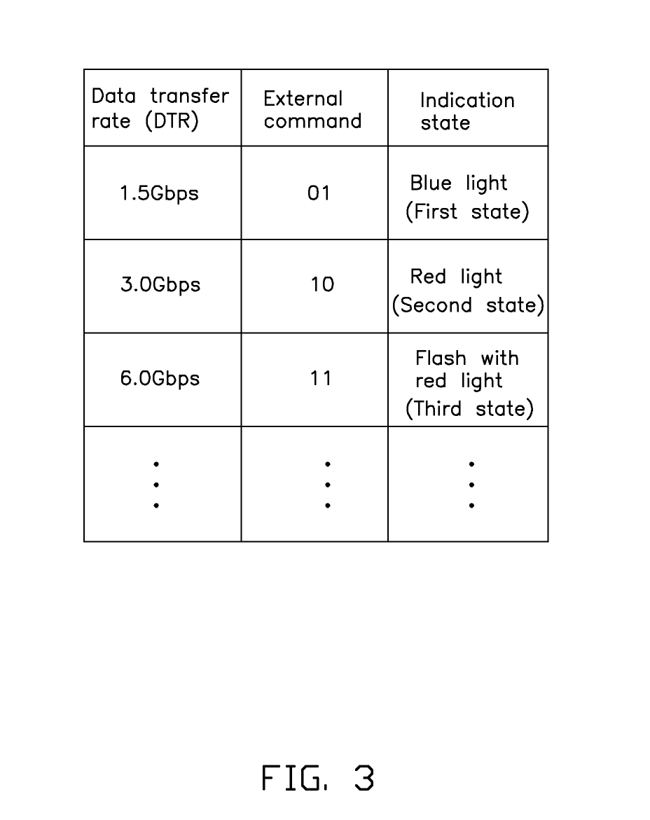

The storage unit 191 stores a predetermined table that records a plurality of predetermined external commands corresponding to the types of DTR of the HDDs 30 and the indication states of the indication unit 170. For example, as shown in FIG. 3, the external commands (e.g., commands 01, 10, and 11) corresponding to different types of DTR and different indication states may be stored in the predetermined table of the storage unit 191.

Additionally, the indication unit 170 further includes a marking unit 172 which records each of the indication states, the DTR and the external command corresponding to each of the indication states. In one embodiment, the marking unit 172 may be a label attached to a predetermined location of the HDD connector 10, to indicate a user of the HDD connector 10.

The setting unit 190 sets a control command that represents the DTR of the HDD 30 connected to each of the HDD interfaces 110. The control command has the same format as the external command stored in the storage unit 191. The setting unit 190 may be a numeric keypad configured for manually setting the control command. The user can manually set the control command according to the marking unit 172 attached on the HDD connector 10.

The control unit 150 receives the control command from the setting unit 190 when the HDD connector 10 is powered, and controls each of the sub-indication units 170 to work at a corresponding indication state by comparing the control command with the external commands of the predetermined table, to indicate the DTR of the HDD 30 connected to each of the HDD interfaces 110. For example, if the control command is the digital command “01”, each of the sub-indication units 170 may work at the first indication state and emit blue light.

Additionally, the control unit 150 further obtains the voltage outputted from the first detection port 111 of each of the HDD interfaces 110 from the detection unit 130 to determine which of the HDD interfaces 110 are connected to the HDD 30, and controls the sub-indication units 171 corresponding to the HDD interfaces 110 which are connected to the HDD 30 to work at the corresponding indication state. Thus, the user can easily know which of the HDD interfaces 110 are connected to the HDD 30 according to the sub-indication units 171.

In use, when the computing device 1 is powered on, the user first sets the control command using the setting unit 190. Then, the detection unit 130 obtains the voltage outputted from the first detection port of each of the HDD interfaces 110, and the control unit 150 determines which of the HDD interfaces 110 are connected to the HDD 30. Thereupon, the control unit 150 receives the control command from the setting unit 190, compares the control command with the external commands of the predetermined table to determine an indication state of the indication unit 170, and controls the sub-indication units 171 of the indication unit 170 corresponding to the HDD interfaces 110 which are connected to the HDD 30 to work at the determined indication state.

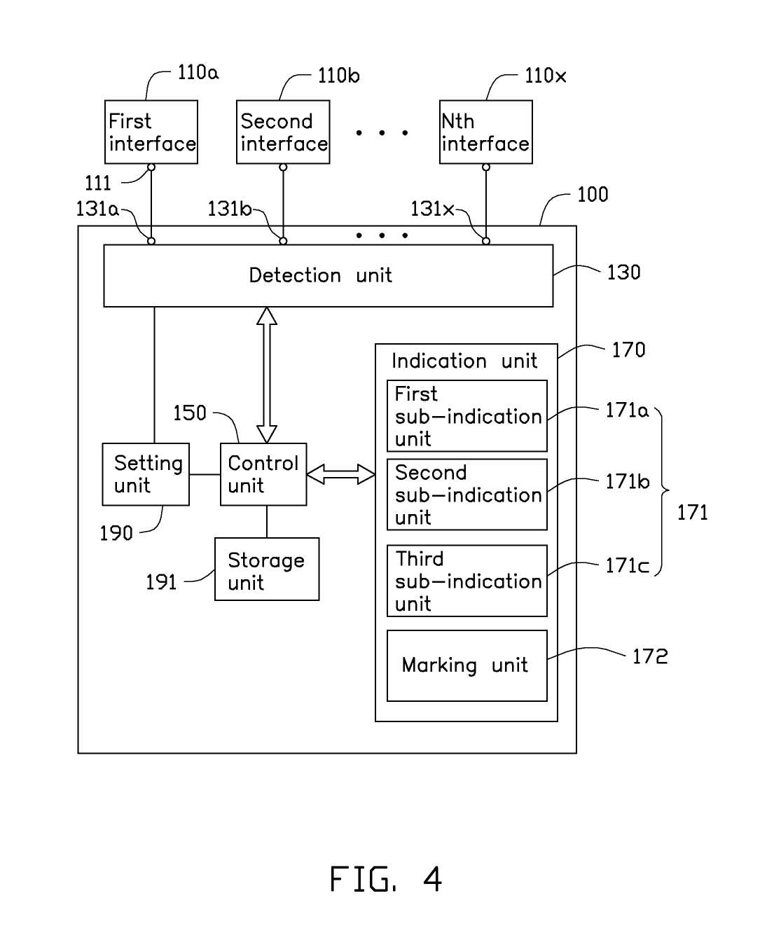

In another embodiment of the indication unit 170, the number of the sub-indication units 171 is equal to a number of types of the DTR supported by the HDD interfaces 110. For example as shown in FIG. 4, if the HDD interfaces 110 only support the DTR of 1.5 Gbps, 3.0 Gbps, and 6.0 Gbps, the indication unit 170 includes a first sub-indication unit 171a, a second sub-indication unit 171b, and a third sub-indication unit 171c respectively corresponding to the DTR of 1.5 Gbps, 3.0 Gbps, and 6.0 Gbps. Each of the first, second, and third sub-indication unit defines one of the indication states. For example, the first sub-indication unit 171a defines the first indication state by emitting blue light to indicate the DTR of 1.5 Gbps. The second sub-indication unit 171b defines the second indication state by emitting red light to indicate the DTR of 3.0 Gbps. The third unit 171c defines the third indication state by flashing with red light to indicate the DTR of 6.0 Gbps. The control unit 150 may control one of the first sub-indication unit 171a, the second sub-indication unit 171b, and the third sub-indication unit 171c to work at its indication state according the control command set by the setting unit to indicate the DTR of each HDD 30 connected to the HDD interfaces 110. Each of the first sub-indication unit 171a, the second sub-indication unit 171b, and the third sub-indication unit 171c may be a single-color LED.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A hard disk drive (HDD) connector, comprising:
a plurality of HDD interfaces being connected to a plurality of HDDs; and
a data transfer rate (DTR) indication device configured for indicating a DTR of each of the HDDs connected to the HDD interfaces, the DTR indication device comprising:
an indication unit defining a plurality of indication states, each of which indicates a type of DTR of the HDDs;
a setting unit setting a control command that represents the DTR of the HDD connected to each of the HDD interfaces; and
a control unit receiving the control command from the setting unit, and controls the indication unit to work at a corresponding indication state according to the control command, to indicate the DTR of each of the HDDs connected to the HDD interfaces.

2. The HDD connector according to claim 1, wherein the DTR indication device further comprises:
a storage unit storing a predetermined table that records a plurality of predetermined external commands corresponding to types of DTR of the HDDs and the indication states of the indication unit.

3. The HDD connector according to claim 2, wherein the control unit controls the indication unit to work at the corresponding indication state by comparing the control command with the external commands of the predetermined table.

4. The HDD connector according to claim 1, wherein the indication unit comprises a plurality of sub-indication units, the plurality of indication states are defined using each of the sub-indication units, and the control unit controls each of the sub-indication units to work at the corresponding indication state according to the control command.

5. The HDD connector according to claim 4, wherein each of the sub-indication units corresponds to one of the HDD interfaces, the DTR indication device further comprises a detection unit electrically connected to each of the HDD interfaces that obtains a voltage outputted from a connection port of each of the HDD interfaces to detect which of the HDD interfaces are connected to the HDD, and the control unit controls the sub-indication units corresponding to the HDD interfaces which are connected to the HDD to work at the corresponding indication state according to the control command.

6. The HDD connector according to claim 5, wherein each of the sub-indication units is a double-color light indicator or a multi-color light indicator, and each of the indication states is defined using the sub-indication units to continuously emit different colored light and/or flash with different colored light.

7. The HDD connector according to claim 4, wherein a number of the sub-indication units is equal to a number of types of the DTR supported by the HDD interfaces, and each of the sub-indication units defines one of the plurality of indication states.

8. The HDD connector according to claim 7, wherein the control unit further controls one of the sub-indication units to work at the corresponding indication state according the control command to indicate the DTR of each of the HDDs connected to the HDD interfaces.

9. The HDD connector according to claim 2, wherein the indication unit further comprises a marking unit that records each of the indication states, the DTR and the external command corresponding to each of the indication states, the marking unit being a label attached to a predetermined location of the HDD connector.

10. The HDD connector according to claim 1, wherein each of the HDDs connected to the HDD interfaces has a same DTR.

11. The HDD connector according to claim 1, wherein the HDD connector is an HDD backpanel.

12. A computing device, comprising:
a hard disk drive (HDD) holding structure; and
an HDD connector installed on the HDD holding structure, the HDD connector comprising a plurality of HDD interfaces being connected to a plurality of HDDs, and a data transfer rate (DTR) indication device configured for indicating a DTR of each of the HDDs connected to the HDD interfaces, wherein the DTR indication device comprises:
an indication unit defining a plurality of indication states, each of which indicates a type of DTR of the HDDs;
a setting unit setting a control command that represents the DTR of the HDD connected to each of the HDD interfaces; and
a control unit receiving the control command from the setting unit, and controls the indication unit to work at a corresponding indication state according to the control command, to indicate the DTR of each of the HDDs that is connected to the HDD interfaces.

13. The computing device according to claim 12, wherein the indication unit comprises a plurality of sub-indication units, the plurality of indication states are defined using each of the sub-indication units, and the control unit controls each of the sub-indication units to work at the corresponding indication state according to the control command.

14. The computing device according to claim 13, wherein each of the sub-indication units corresponds to one of the HDD interfaces, the DTR indication device further comprises a detection unit electrically connected to each of the HDD interfaces that obtains a voltage outputted from a connection port of each of the HDD interfaces to detects which of the HDD interfaces are connected to the HDD, and the control unit controls the sub-indication units corresponding to the HDD interfaces which are connected to the HDD to work at the corresponding indication state according to the control command.

15. The computing device according to claim 14, wherein each of the sub-indication units is a double-color light indicator or a multi-color light indicator, and each of the indication states is defined using the sub-indication units to emit different colored light and/or flash with different colored light.

16. The computing device according to claim 13, wherein a number of the sub-indication units is equal to a number of types of the DTR supported by the HDD interfaces, and each of the sub-indication units defines one of the plurality of indication states.

17. The computing device according to claim 16, wherein the control unit further controls one of the sub-indication units to work at the corresponding indication state according to the control command to indicate the DTR of each of the HDDs that is connected to the HDD interfaces.

18. A data transfer rate (DTR) indication device for indicating a DTR of at least one hard disk drive (HDD) connected to an HDD connector of a computing device, the DTR indication device comprising:
an indication unit defining a plurality of indication states, each of which indicates a type of DTR of the at least one HDD;
a setting unit setting a control command that represents the DTR of the HDD connected to the HDD connector; and
a control unit receiving the control command from the setting unit, and controls the indication unit to work at a corresponding indication state according to the control command, to indicate the DTR of each of the at least one HDD.

19. The DTR indication device according to claim 18, wherein the indication unit comprises a plurality of sub-indication units, the plurality of indication states are defined using each of the sub-indication units, and the control unit controls each of the sub-indication units to work at the corresponding indication state according to the control command.

20. The DTR indication device according to claim 18, wherein each of the sub-indication units is a light indicator, and each of the indication states is defined using the sub-indication units to emit different colored light and/or flash with different colored light.
